(19) United States
(12) Patent Application Publication
(10) Pub. No.: US 2012/0301846 A1
(43) Pub. Date: Nov. 29, 2012

(54) DENTAL TREATMENT AID DEVICE

(76) Inventor: Muriel Mizrahi, Netanya (IL)

(21) Appl. No.: 13/576,404

(22) PCT Filed: Feb. 1, 2011
(86) PCT No.: PCT/IL2011/000119

§ 371 Date: Aug. 1, 2012

(30) Foreign Application Priority Data
Feb. 14, 2010 (IL) 203933

(51) Int. Cl. A61C 5/14

(52) U.S. Cl. 433/136

(57) ABSTRACT

In one aspect, the present invention is directed to a dental treatment aid device, comprising: a substantially annular frame (14) having at least two resilient opposite points on the frame; and a gauze (16) enclosed by the frame (14) and attached to the frame (14); wherein the dimensions of the frame allows placing the frame, in a folded state, into a patient's mouth, between the palate and tongue thereof; thereby the resiliency of the frame affix the frame to the walls of the mouth of the patient, thereby preventing solid objects from entering the pharynx of the patient while undergoing dental treatment.

### FIELD OF THE INVENTION

The present invention relates to the field of dental treatment aid devices. More particularly, the invention relates to a dental treatment aid device for preventing solid objects from entering the pharynx of a patient during a dental treatment.

### BACKGROUND OF THE INVENTION

The human pharynx, or throat, serves as a passage for two systems: the respiratory and digestive systems. Air and food pass through the pharynx as they move downward.

During dental treatment, especially when a patient lies horizontally on the treatment chair, elements used for the dental treatment, such as dental crowns, may fall into the pharynx, and throttle the patient.

An essential equipment of dentist's chairs is a saliva pump. During a dental treatment, the nozzle of the pump is placed under the tongue of a patient, where the saliva accumulates, and pumps the saliva from the patient's mouth, thereby preventing the saliva from entering the pharynx, which may result in throttle.

Although the saliva pump is a proper solution for liquids, it cannot solve the problem of objects that may fall unintentionally into the patient's mouth during dental treatment. As such, there is a long understood need for a solution for this problem.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a dental treatment aid device, comprising:
a substantially annular frame (14) having at least two resilient opposite points on the frame; and
a gauze (16) enclosed by the frame (14) and attached to the frame (14);

wherein the dimensions of the frame allows placing the frame, in a folded state, into a patient's mouth, between the palate and tongue thereof;

thereby the resiliency of the frame affix the frame to the walls of the mouth of the patient, thereby preventing solid objects from entering into the pharynx of the patient while undergoing dental treatment.

According to one embodiment of the invention, the size of the frame is adjustable, thereby allowing fitting the device to patients with different mouth dimensions.

According to one embodiment of the invention, the mechanism that allows the frame to be adjustable is a telescopic mechanism applied on at least one point of the frame (illustrated in FIG. 7 and detailed in the description thereof).

According to one embodiment of the invention, the gauze if stretchable, thereby allows fitting the gauze to frames of different dimensions.

According to one embodiment of the invention, the frame comprises two substantially identical profiles, attached by bolts. According to this embodiment of the invention, the gauze is disposed between the frames, thereby upon securing the frames the gauze is attached by the frame and/or the bolts.

According to one embodiment of the invention, the frame comprises ledges along the extent thereof, for hooking the gauze.

Preferably, the ledges do not outstand from the edges of the frame, thereby preventing injury to the mouth of the patient.

According to one embodiment of the invention, the entire frame is made of resilient material, thereby (a) allowing fitting the frame to the specific form of a patient's mouth, and (b) allowing hooking the gauze to ledges on the frame.

According to one embodiment of the invention, the gauze is made of stretchable material, thereby allowing using said gauze in frames of different sizes.

The frame may be made of rigid and resilient parts.

The device may be manufactured in different dimensions, thereby allowing fitting to patients with different mouth dimensions.

The reference numbers have been used to point to elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a dental treatment aid device, according to one embodiment of the invention, before insertion into the mouth of the patient.

FIG. 2 schematically illustrates the device of FIG. 1, placed in a patient's mouth.

FIG. 3 schematically illustrates a dental treatment-aid device, according to one embodiment of the invention.

FIG. 4 schematically illustrates a dental treatment aid device, according to another embodiment of the invention.

FIG. 5 is an exploded view that schematically illustrates a dental treatment aid device, according to yet another embodiment of the invention.

FIG. 6 schematically illustrates a dental treatment aid device, according to yet another embodiment of the invention.

FIG. 7 schematically illustrates a dental treatment aid device, according to yet another embodiment of the invention.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

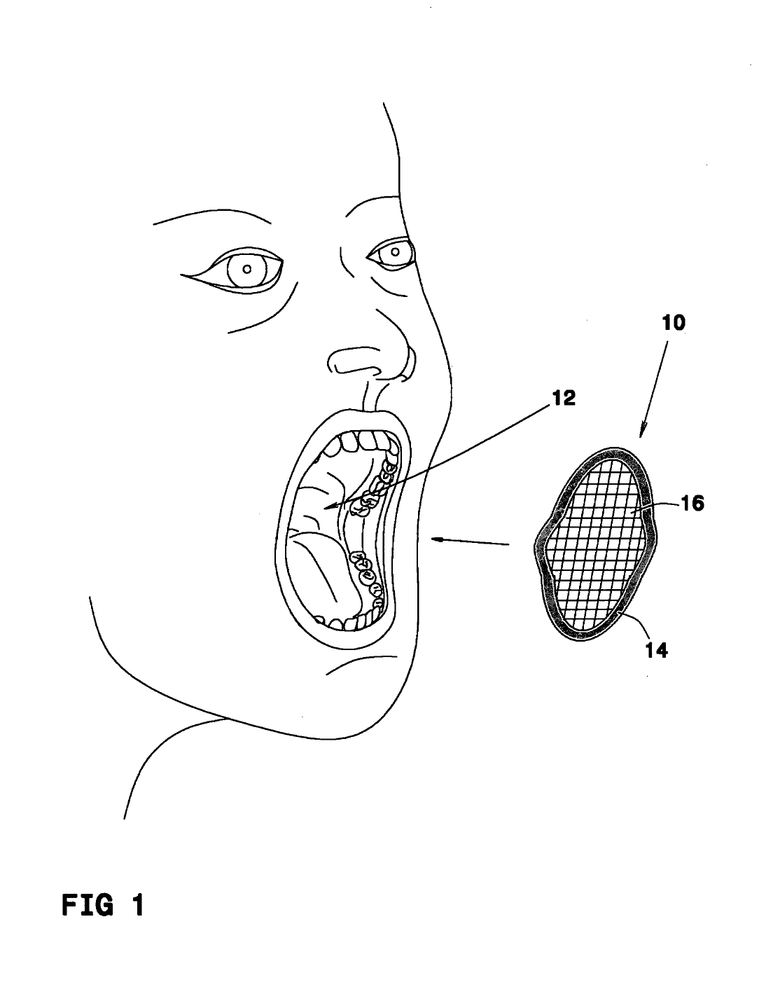

FIG. 1 schematically illustrates a dental treatment aid device, according to one embodiment of the invention, before insertion into the mouth of the patient.

The device, which is marked herein by reference numeral 10, comprises a substantially annular, resilient frame 14, and gauze 16 enclosed by frame 14 and attached to the frame.

The frame is designed such that the dimensions thereof will allow placing the device, in a folded state, into the mouth of a patient, between the palate and tongue.

When device 10 is released into the mouth of a patient, the resiliency of the frame, i.e., the force that causes the bent frame to return to its original form, affixes the frame in the patient's mouth.

The substantially annular form of the frame allows covering the pharynx of a patient, and prevents harming the patient's mouth wall by sharp edges.

As a result, if during the dental treatment, a solid object falls unintentionally from the dentist's hands into the patient's mouth, it is blocked by gauze 16, thereby preventing the patient to exposure to throttle danger from such objects.

The term “gauze” refers herein to a semitransparent weave that on the one hand prevents objects of a certain size (depending on the hollows of the weave) from passing therethrough, and on the other hand allows airflow therethrough.

According to one embodiment of the invention, the entire frame is made of resilient material, thereby (a) allowing fitting the frame to the specific form of a patient's mouth, and (b) allowing bending the frame for hooking the gauze thereon.

According to another embodiment of the invention, parts of the frame are made of rigid material(s), while other parts are made of resilient material(s).

The materials may be plastic, metal, rubber, stainless steel, springy material, and so on.

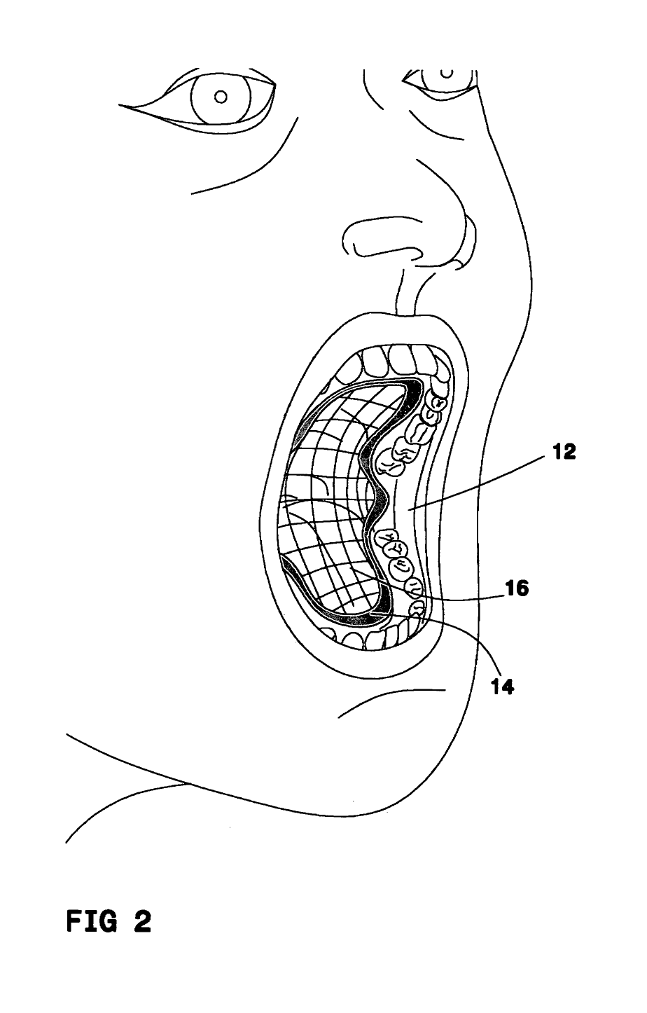

FIG. 2 schematically illustrates the device of FIG. 1, placed in a patient's mouth.

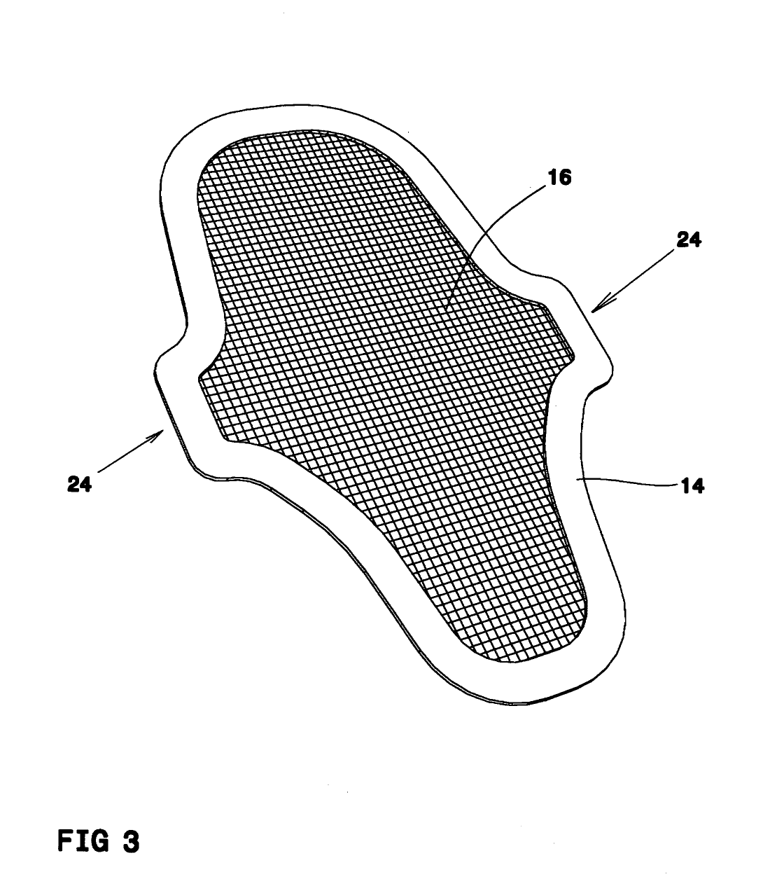

FIG. 3 schematically illustrates a dental treatment-aid device, according to one embodiment of the invention.

As mentioned, device 10 comprises a substantially annular frame 14, and gauze 16, enclosed by frame 14 and attached to the frame. Frame 14 comprises at least two resilient opposite points 24, in order to allow bending the frame before placing in a patient's mouth, and holding the device in a patient's mouth by applying the resiliency force on the interior walls of the mouth, as the bent frame tends to return to its original form.

On the one hand, the size of the holes of gauze 16 must be smaller than the size of objects used during dental treatment, in order to prevent such objects from passing therethrough. For example, a dentist may unintentionally drop a dental crown during dental treatment. On the other hand, the size of the gauze has to allow free air passage therethrough, as some people prefer to breathe through the mouth.

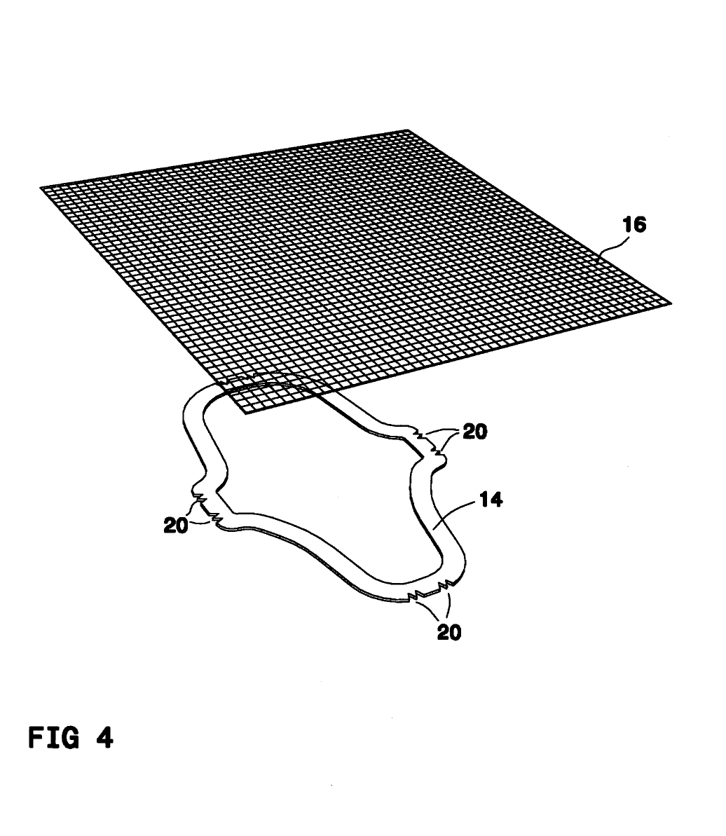

FIG. 4 schematically illustrates a dental treatment aiding device, according to another embodiment of the invention.

According to this embodiment of the invention, frame 14 comprises ledges 20, to which gauze 16 can be hooked.

It should be noted that the ledges do not outstand from the edges of the frame, in order to prevent cutting the walls of the mouth of a patient.

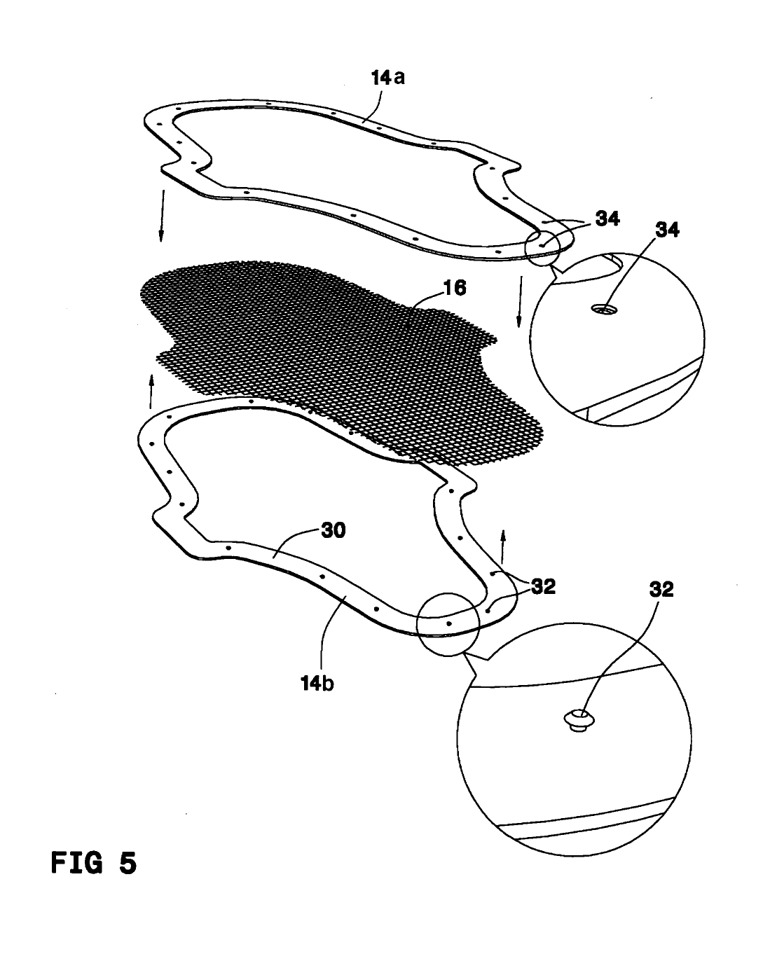

FIG. 5 is an exploded view that schematically illustrates a dental treatment aid device, according to yet another embodiment of the invention.

The frame comprises two parts, 14a and 14b, having substantially the same form. Gauze 16 is placed between frames 14a and 14b, and the entire structure (comprising frames 14a, 14b and gauze 16) is secured by bolts 32 of frame 14b and corresponding bores 34 in frame 14a.

In the manufacturing process, after these parts have been interlaced, a pressure is applied on bolts 32, thereby deforming the tops of the bolts, which results in securing the frames while the gauze is disposed therebetween.

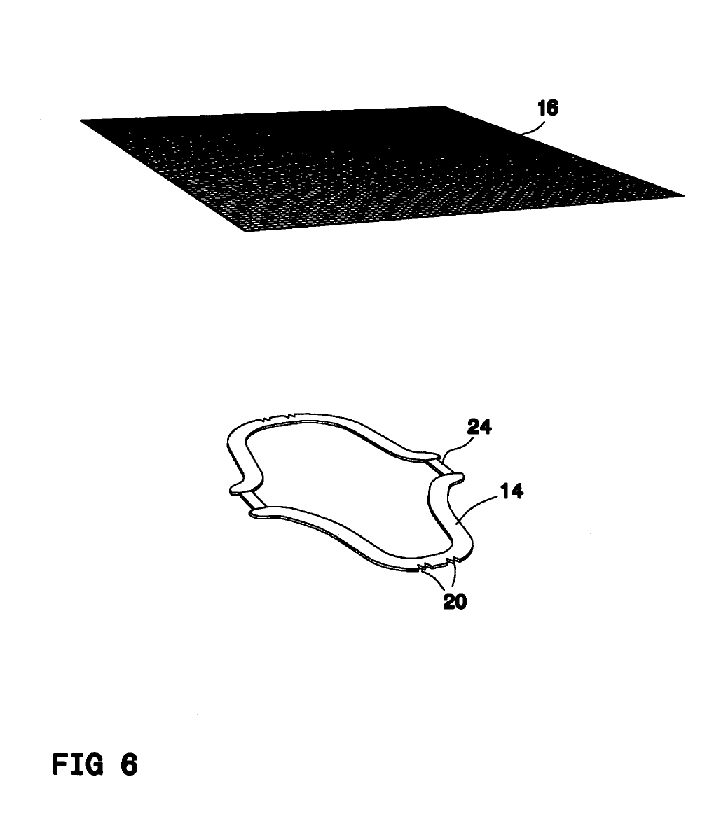

FIG. 6 schematically illustrates a dental treatment aid device, according to yet another embodiment of the invention.

According to this embodiment of the invention, the resiliency of frame 14 is achieved by providing resilient regions/points 24, at opposite sides of the frame. Thus, according to this embodiment of the invention, only certain regions of the fame are resilient.

According to another embodiment of the invention, the entire frame is made of resilient material, thereby allowing the frame to deform according to the form of the human mouth in which it is placed.

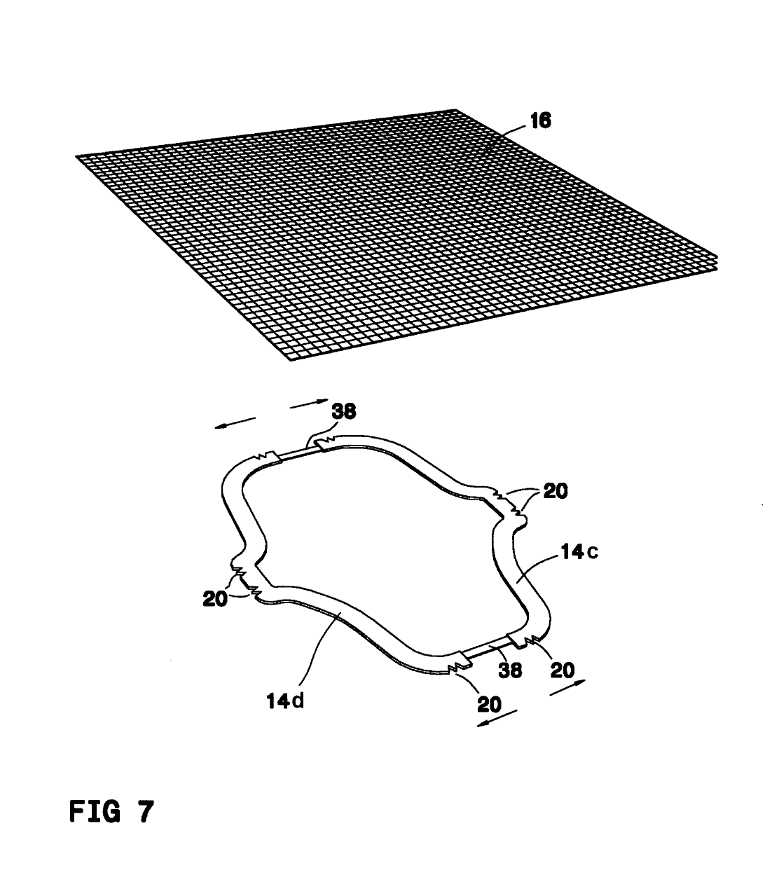

FIG. 7 schematically illustrates a dental treatment aid device, according to yet another embodiment of the invention.

According to this embodiment, shaft 38 is a part of a telescopic mechanism that allows adjusting the form of the frame, in order to fit the mouth dimensions of a patient.

The telescopic mechanism operates as follows: reed 38 is attached to, for example, part 14c of the frame, while part 14d has a bore (not seen) which mates with the reed 38. The arrows illustrate the separation direction of part 14c from part 14d. The dimensions of the bore are designed such that the friction between the bore and the reed generate objection to changing the distance between parts 14c and 14b of the frame. However, a user may apply more power to adjust the distance between parts 14c and 14d to a desired distance. Thus, while the frame is placed in a patient's mouth, the distance between parts 14a and 14b of the frame remains constant.

Gauze 16 is attached to the frame by ledges 20.

According to one embodiment of the invention, the contour of the gauze may be larger than the contour of the unexpended frame, thereby even if the frame expands, the gauze still can be used with the expanded frame.

According to another embodiment of the invention, the gauze is made of stretchable material, which allows to be suitable to frames of different size.

Of course, these are merely examples, and other adjusting mechanisms may be used.

The dental treatment aid device may be manufactured in different dimensions, thereby allowing it to be used by patients having different mouth dimensions.

In the figures and/or description herein, the following reference numerals have been mentioned:
numeral 10 denotes a dental treatment aid device, according to one embodiment of the invention;
numeral 12 denotes the mouth of a patient;
numeral 14 denotes the frame of device 10;
numerals 14a and 14b denote frames of substantially the same form, which enclose therebetween a gauze, according to one embodiment of the invention;
numerals 14c and 14d denote parts of the same frame;
numeral 16 denotes a gauze of device 10;
numeral 20 denotes ledges to which a gauze can be attached/hooked;
numeral 24 denotes a resilient region of frame 14;
numeral 32 denotes bolts attached to frame 14b;
numeral 34 denotes bores in frame 14a, corresponding to bolts 32; and
numeral 38 denotes a reed, which is a part of a telescopic mechanism for connecting parts 14c and 14d of a frame.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. A dental treatment aid device, comprising:
a substantially annular frame having at least two resilient opposite points on said frame; and
a gauze enclosed by said frame and attached to said frame;
wherein the dimensions of said frame allows placing said frame, in a folded state, into a patient's mouth, between the palate and tongue thereof;
thereby the resiliency of said frame affix said frame to the walls of the mouth of said patient,
thereby preventing solid objects from entering into the pharynx of said patient while undergoing dental treatment.

2. A device according to claim 1, wherein the size of said frame is adjustable, thereby allowing fitting said device to patients with different mouth dimensions.

3. A device according to claim 2, wherein the mechanism that allows said frame to be adjustable is a telescopic mechanism applied on at least one point of said frame.

4. A device according to claim 1, wherein said gauze is stretchable, thereby allowing fitting said gauze to frames of different dimensions.

5. A device according to claim 1, wherein said frame comprises two substantially identical profiles, attached by bolts, wherein said gauze is disposed therebetween, thereby being attached by said frame and/or said bolts.

6. A device according to claim 1, wherein said frame comprises ledges along the extent thereof, for hooking said gauze.

7. A device according to claim 6, wherein said ledges do not outstand from the edges of said frame, thereby preventing injury of the mouth of said patient.

8. A device according to claim 1, wherein the entire frame is made of resilient material, thereby (a) allowing fitting said frame to the specific form of a patient's mouth, and (b) allowing hooking said gauze to ledges on said frame.

9. A device according to claim 1, wherein said gauze is made of stretchable material.

10. A device according to claim 1, manufactured in different dimensions, thereby allowing fitting to patients of different mouth dimensions.

11. A device according to claim 1, wherein said frame is made of rigid and resilient parts.
